(19) United States
(12) Patent Application Publication
(10) Pub. No.: US 2003/0211781 A1
(43) Pub. Date: Nov. 13, 2003

(54) Electric connector whose shield plate is equipped with anti-bending means for its pressfit pieces

(76) Inventors: Koji Ono, Tokyo (JP); Kiyoshi Ooaku, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/426,639

(22) Filed: May 1, 2003

(30) Foreign Application Priority Data
May 9, 2002 (JP) 2002-133972

(51) Int. Cl. H01R 13/648

(52) U.S. Cl. 439/607

(57) ABSTRACT

Disclosed is an improved shielded electric connector comprising a connector body having contact pieces embedded therein and an “L”-shaped shield plate applied to the connector body with its horizontal and vertical sections lying on the top surface and rear side of the connector body, the shield plate having press-fit portions integrally connected to the lower end of the vertical section. The shield plate has thrust shoulders formed at its horizontal-to-vertical transition to push the press-fit portions. The electric connector can be fixed to a printed circuit board by applying a push to the thrust shoulders of the shield plate, thereby pushing the press-fit portions of the shield plate right in the through holes in exact linear-alignment with the through holes. Thus, the strong thrust can be transmitted to each press-fit portion without any possibility of causing it to be deformed or bent.

### BACKGROUND OF THE INVENTION

1. Field of the Invention

The present invention relates to a hard-metric (abbreviated as HM) connector of the type used in exchangers, servers or computers. It uses a press-fit type of shield plate to facilitate the mounting of the shielded connector onto a printed circuit board.

2. Related Art

Referring to FIG. 5(A), (B) and (C), a conventional electric connector 10 has a press-fit type of “L”-shaped shield plate 13 tentatively fastened to its body 12 by making the engagement extensions of the flat top 13a of the shield 13 to be caught on the front side of the connector body 12. The shield plate 13 has a vertical section 13b extending downward via bent round portion 13c. The rear part of the connector body 12 has its bottom raised at a level higher than the bottom of the front part, thus leaving a space to accommodate a printed circuit board 11. As seen from FIG. 5(C), the rear part of the connector body has the male contact portions 3b of the contact pieces 3 projecting downward from the raised bottom, and press-fit portions 13d of the vertical section 13b of the shield plate 13 extend parallel to the male contact portions 3b of contact pieces 3 so that their tapering ends may be coplanar with the tapering ends of the male contact portions 3b. The connector body 12 has female receptacles arranged in the form of lattice on its front side, in which the female contact portions of the contact pieces 3 are inserted.

When the electric connector 10 is fixed to the printed circuit board 11, an “L”-shaped pressing tool having a round corner approximately corresponding to the bent round portion 13c of the shield plate 13 is applied to the shielded connector body, and then, a strong thrust is applied to the flat top 13a to push the male contact portions 3b and the press-fit portions 13d into the though-holes of the printed circuit board 11.

Application of a several Newton-strong push to each male contact portion and press-fit portion is apt to bend some or all press-fit portions. Also disadvantageously, before applying a thrust to the connector the “L”-shaped shield plate needs to be tentatively fastened to the connector body 12 with a piece of both-sided adhesive tape. This is an elaborate, time consuming work.

One object of he present invention is to provide a shielded electric connector which is guaranteed to be free of such defects as described above.

### SUMMARY OF THE INVENTION

To attain this object an electric connector comprising a connector body having contact pieces embedded therein and an “L”-shaped shield plate applied to the connector body with its horizontal and vertical sections lying on the top surface and rear side of the connector body respectively, the shield plate having press-fit portions formed at the lower end of the vertical section, is improved according to the present invention in that the shield plate has a plurality of thrust shoulders formed at its horizontal-to-vertical transition to push the press-fit portions.

The electric connector can be fixed to a printed circuit board by applying a push to the thrust shoulders of the shield plate, thereby pushing the press-fit portions of the shield plate right in the through holes in exact linear-alignment with the through holes. Thus, the strong thrust can be transmitted to each press-fit portion without any possibility of causing it to be deformed or bent.

The shield plate may have engagement extensions formed ahead of its horizontal section, and engagement projections formed in its vertical section; and the connector body may have catch means formed on its front and rear sides respectively, whereby the shield plate can be attached to the connector body.

This arrangement facilitates the tentative fastening of the shield plate to the connector body without the necessity of using any adhesive agent and/or a both-sided adhesive tape.

Other objects and advantages of the present invention will be understood from the following description of a shielded electric connector according to one preferred embodiment of the present invention, which is shown in accompanying drawings.

### BRIEF DESCRIPTION OF THE DRAWING

FIGS. 1(A), 1(B) and 1(C) are plane, front and side views of a shielded electric connector according to the present invention;

FIG. 2 is a plane view of the shield plate prior to bending into the final shape;

FIGS. 3(A) and 3(B) are rear and side views of the shield plate;

FIG. 4(A) is a side view of the electric connector, partly in section taken along the line “4(A)”-“4(A)” in FIG. 1(A); FIGS. 4(B) and 4(C) are sectional views of the fragments of the shield plate including the horizontal-to-vertical transition of the connector, taken along the line “4(C)”-“4(C)” in FIG. 3(A), and the line “4(B)”-“4(B)” in FIG. 3(A) respectively; and FIG. 4(D) is an enlarged perspective view showing the thrust shoulder of the shield plate;

FIGS. 5(A), 5(B) and 5(C) are plane, front and side views of a conventional shielded electric connector respectively; and

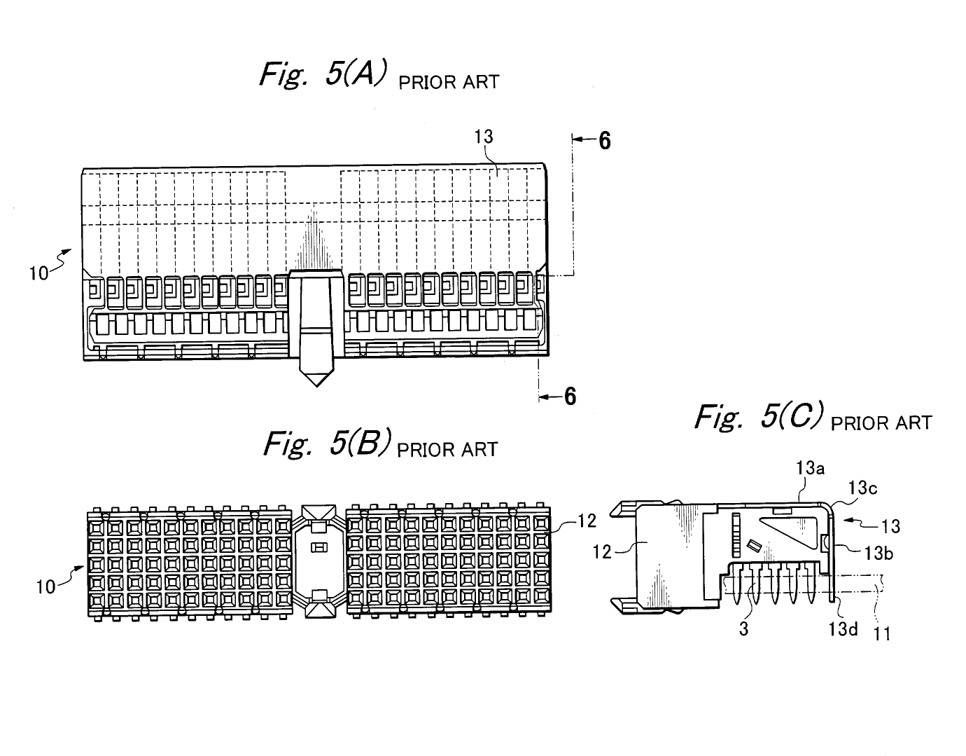

FIG. 6 is a side view of the conventional electric connector, partly in section, taken along the line “6”-“6” in FIG. 5(A).

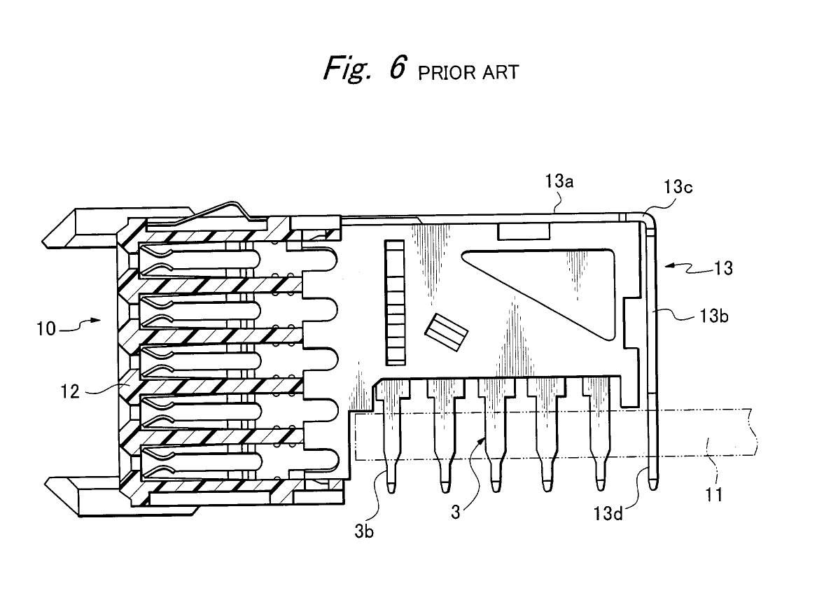

### DETAILED DESCRIPTION OF PREFERRED EMBODIMENT

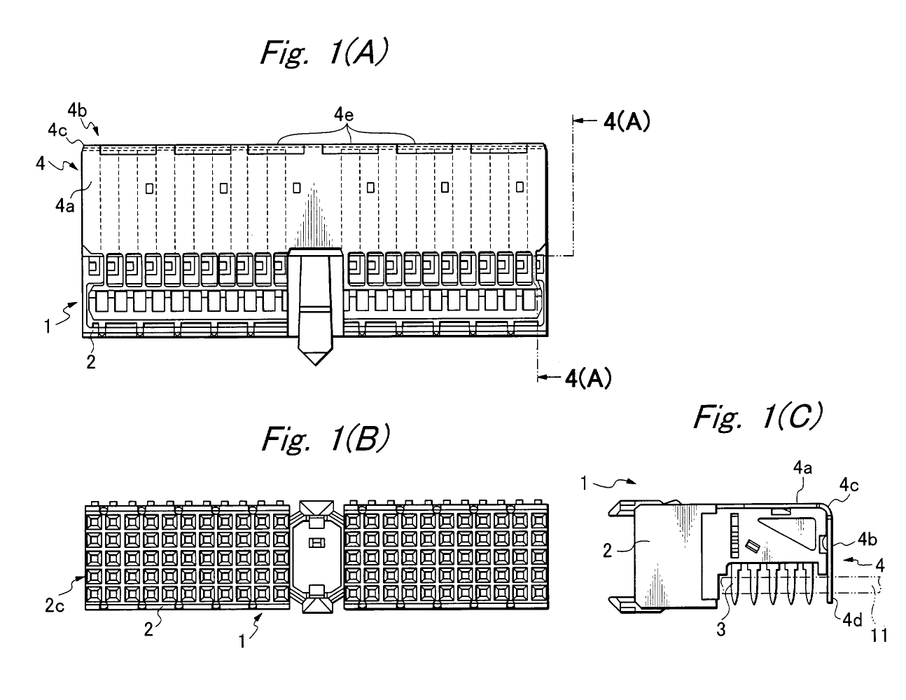

Referring to FIG. 1, an HM connector 1 comprises a connector body 2 having contact pieces 3 insert-molded therein and an “L”-shaped shield plate 4 applied to the connector body 2 with its horizontal and vertical sections 4a and 4b lying on the top surface 2a and rear side 2b of the connector body 2. The shield plate 4 has press-fit portions 4d integrally connected to the lower end of the vertical section 4b of the shield plate 4.

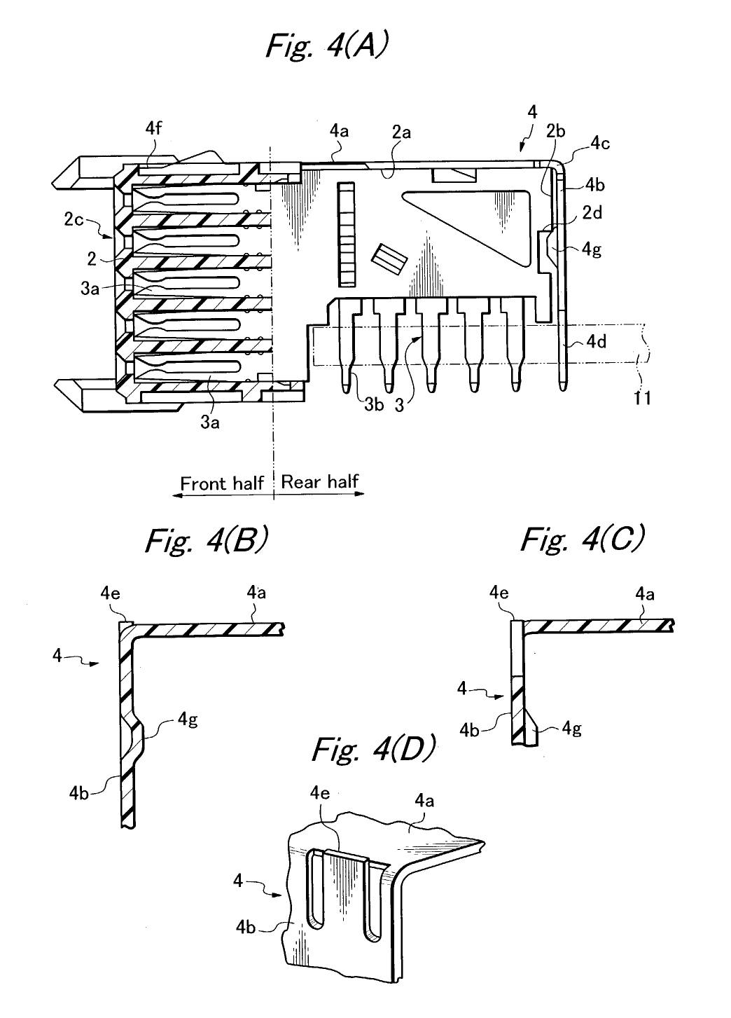

Referring to FIG. 4(A), the connector body 2 comprises front and rear halves integrally connected by insert molding contact pieces 3. The front half has a plurality of female receptacles 2c made in the form of lattice, and the female contact portions 3a are inserted in the female receptacles 2c. The rear half of the contact body 2 has the intermediate lengths of the contact pieces 3 embedded therein. The vertical extensions of the contact pieces 3 partly appear from the bottom of the rear half of the conductor body 2 to provide male contact portions 3b. As shown in FIG. 4(A), the male contact portions 3b are pushed in selected through holes made in the printed circuit board 11.

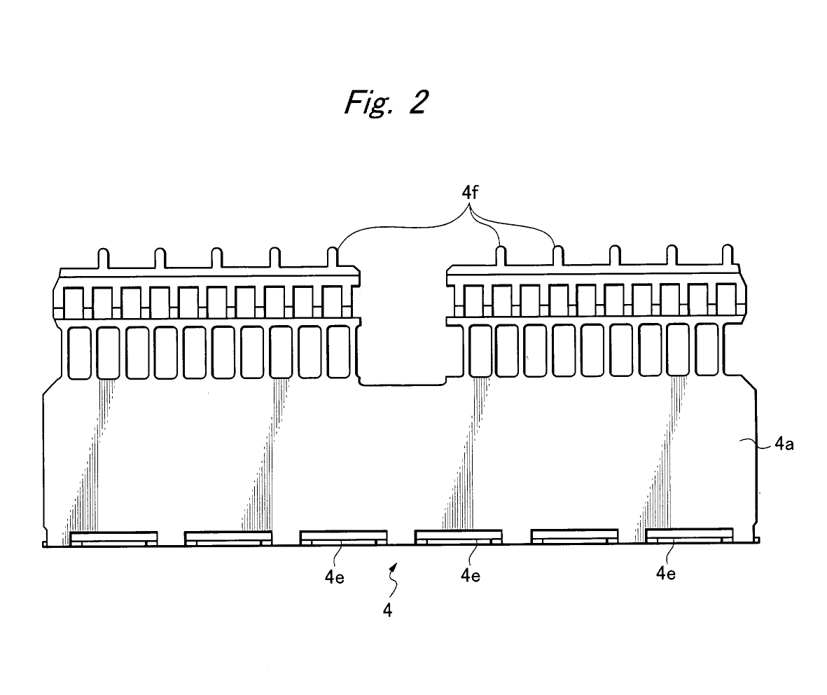

As shown in FIG. 2, the shield plate 4 has a plurality of thrust shoulders 4e formed at its horizontal-to-vertical transition 4c for use in pushing the press-fit portions 4d in the through holes of the printed circuit board 11. Such thrust shoulders 4e can be formed by making flattened “U”-shaped cuts in a selected linear stripe portion extending from side to side, which linear stripe portion is to be bent at right angles to form a horizontal-to-vertical transition on its rear side when bending the shield plate into its final shape.

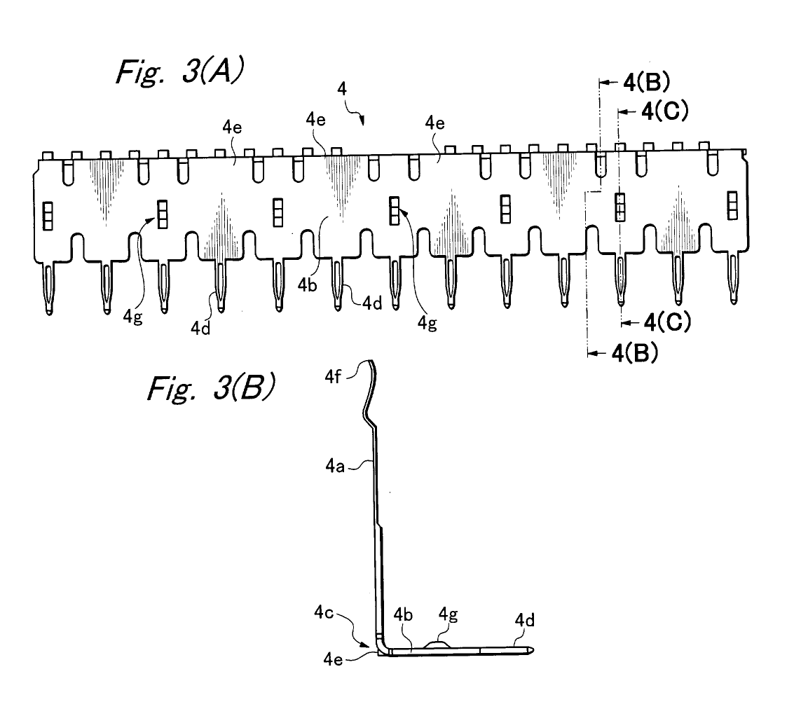

Referring to FIGS. 2 to 4, the shield plate 4 has engagement extensions 4f formed ahead of the top flat 4a on its front side (FIG. 2), and engagement projections 4g formed on the vertical section 4b. The shield plate 4 can be fastened to the connector body 2 by allowing the engagement extensions and portions 4f and 4g to be caught by catch portions or recesses 2d. Thus, a shielded electric connector is provided.

The shielded electric connector thus provided can be fastened to a printed circuit board 11 simply by applying a thrust to the thrust shoulders 4e of the “L”-shaped shield 4 to push the male contact portions 3b and the press-fit portions 4d in the through holes of the printed circuit board 11. The thrust can be transmitted right from the thrust shoulders 4e to the press-fit portions 4d of the vertical section 4b of the “L”-shaped shield 4 so that the press-fit portions 4d may be pushed in selected through holes in the printed circuit board 11 without being deformed or bent.

What is claimed is:

1. An electric connector comprising a connector body having contact pieces embedded therein and an “L”-shaped shield plate applied to the connector body with its horizontal and vertical sections lying on the top surface and rear side of the connector body respectively, the shield plate having press-fit portions formed at the lower end of the vertical section, wherein the shield plate has a plurality of thrust shoulders formed at its horizontal-to-vertical transition to push the press-fit portions.

2. An electric connector according to claim 1, wherein the shield plate has engagement extensions formed ahead of its horizontal section, and engagement projections formed in its vertical section; and the connector body has catch means formed on its front and rear sides respectively, whereby the shield plate can be attached to the connector body.
